(19) United States
(12) Patent Application Publication
(10) Pub. No.: US 2017/0178127 A1
(43) Pub. Date: Jun. 22, 2017

(54) PROXY SYSTEM MEDIATED LEGACY TRANSACTIONS USING MULTI-TENANT TRANSACTION DATABASE

(71) Applicant: International Business Machines Corporation, Armonk, NY (US)

(72) Inventor: David William Kravitz, San Jose, CA (US)

(21) Appl. No.: 14/975,066

(22) Filed: Dec. 18, 2015

(51) Int. Cl. G06Q 20/38; G06Q 20/42; G06Q 20/40

(52) U.S. Cl. CPC G06Q 20/38215; G06Q 20/3829; G06Q 20/401; G06Q 20/42; G06Q 2220/00

(57) ABSTRACT

One embodiment provides a method for proxy system mediated legacy transactions using multi-tenant transaction database, including: utilizing at least one processor to execute computer code that performs the steps of: ascertaining, using a processor associated with a proxy system, that a first transacting entity and a second transacting entity have placed a transaction on a multi-tenant transaction database, the transaction including transfer of a legacy asset; decrypting, using a processor associated with the proxy system, a legacy system account access credential of the second transacting entity included in the transaction, the decrypting comprising recovery of a function of a public key corresponding to a private key associated with the second transacting entity; confirming, using a processor associated with the proxy system, that the legacy system account credential authorizes the second transacting entity to transfer the legacy asset; and transferring, using a processor associated with the proxy system, the legacy asset from the second transacting entity to the first transacting entity. Other aspects are described and claimed.

### BACKGROUND

A time-sequenced immutable database, for example, implemented using block chain technology (also referenced as “blockchain”), is a distributed database that is implemented using a plurality of nodes. The nodes each maintain a copy of a sequentially growing list or ledger of data records or query one or more other nodes. An example of a block chain implementation is a public ledger used for crypto-currency transactions. The data of a block chain may be protected by encryption and may include data other than crypto-currency transactions, e.g., smart contracts may be implemented using a block chain.

The functionality of block chain technology has garnered much interest; however, widespread adoption of such technology has been hindered by reservations regarding anonymous transactions and a lack of clarity as to which entities are involved in a transaction, their past contributions to the database, and their authority to act in certain transactions. Moreover, legacy systems that operate using conventional credentials such as user name/password pairs, account numbers, etc., such as digital content provider systems, credit card and bank transaction processing systems, etc., were not designed with block chain technology in mind. Thus, such legacy systems are thought to be incapable of utilizing such block chain technology.

### BRIEF SUMMARY

In summary, one aspect of the invention provides a method for proxy system mediated legacy transactions using multi-tenant transaction database, comprising: utilizing at least one processor to execute computer code that performs the steps of: ascertaining, using a processor associated with a proxy system, that a first transacting entity and a second transacting entity have placed a transaction on a multi-tenant transaction database, the transaction including transfer of a legacy asset; decrypting, using a processor associated with the proxy system, a legacy system account access credential of the second transacting entity included in the transaction, the decrypting comprising recovery of a function of a public key corresponding to a private key associated with the second transacting entity; confirming, using a processor associated with the proxy system, that the legacy system account credential authorizes the second transacting entity to transfer the legacy asset; and transferring, using a processor associated with the proxy system, the legacy asset from the second transacting entity to the first transacting entity.

Another aspect of the invention provides an apparatus for proxy system mediated legacy transactions using multi-tenant transaction database, the apparatus comprising: at least one processor; and a computer readable storage medium having computer readable program code embodied therewith and executable by the at least one processor, the computer readable program code comprising: computer readable program code that ascertains, using a processor associated with a proxy system, that a first transacting entity and a second transacting entity have placed a transaction on a multi-tenant transaction database, the transaction including transfer of a legacy asset; computer readable program code that decrypts, using a processor associated with the proxy system, a legacy system account access credential of the second transacting entity included in the transaction, wherein the computer readable program that decrypts recovers a function of a public key corresponding to a private key associated with the second transacting entity; computer readable program code that confirms, using a processor associated with the proxy system, that the legacy system account credential authorizes the second transacting entity to transfer the legacy asset; and computer readable program code that transfers, using a processor associated with the proxy system, the legacy asset from the second transacting entity to the first transacting entity.

An additional aspect of the invention provides a computer program product for proxy system mediated legacy transactions using multi-tenant transaction database, the computer program product comprising: a computer readable storage medium having computer readable program code embodied therewith that is executable by at least one processor, the computer readable program code comprising: computer readable program code that ascertains, using a processor associated with a proxy system, that a first transacting entity and a second transacting entity have placed a transaction on a multi-tenant transaction database, the transaction including transfer of a legacy asset; computer readable program code that decrypts, using a processor associated with the proxy system, a legacy system account access credential of the second transacting entity included in the transaction, wherein the computer readable program that decrypts recovers a function of a public key corresponding to a private key associated with the second transacting entity; computer readable program code that confirms, using a processor associated with the proxy system, that the legacy system account credential authorizes the second transacting entity to transfer the legacy asset; and computer readable program code that transfers, using a processor associated with the proxy system, the legacy asset from the second transacting entity to the first transacting entity.

A further aspect of the invention provides a method for proxy system mediated legacy transactions that are executed externally to a multi-tenant transaction database, comprising: utilizing at least one processor to execute computer code that performs the steps of: ascertaining, using a processor associated with a proxy system, that a first transacting entity and a second transacting entity each contributed towards submitting a transaction for placement on the multi-tenant transaction database, the transaction including a representation of transfer of a legacy asset; and decrypting, using a processor associated with the proxy system, an encrypted, augmented legacy system account access credential of the second transacting entity included in the transaction, the decrypting resulting in recovery of a function of a public key corresponding to a private key associated with the second transacting entity, wherein said private key is associated with the second transacting entity by the second transacting entity using the private key to contribute towards submitting the transaction for placement on the multi-tenant database; confirming, using a processor associated with the proxy system, that the legacy system account credential authorizes the second transacting entity to transfer the legacy asset; and transferring, using a processor associated with the proxy system, the legacy asset from the second transacting entity to the first transacting entity.

Another aspect of the present invention provides a method for proxy system mediated legacy transactions that are executed externally to a multi-tenant transaction database, comprising: utilizing at least one processor to execute computer code that performs the steps of: ascertaining, using a processor associated with a proxy system, that a first transacting entity and a second transacting entity each contributed towards submitting a transaction for placement on the multi-tenant transaction database, the transaction including a representation of transfer of a legacy asset; and verifying, using a processor associated with the proxy system, a signature that is generated by the second transacting entity as part of contributing towards submitting the transaction for placement on the multi-tenant database, wherein said verifying comprises using a public key, wherein a function of the public key is recovered by a processor associated with the proxy system via decryption of a previous transaction submitted by the same entity for placement on the multi-tenant database.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates an example system framework.

FIG. 2 illustrates an example of a proxy system mediated legacy transaction using multi-tenant transaction database.

FIG. 3 illustrates an example of proxy mediated, legacy asset smart contracting using a multi-tenant transaction database.

FIG. 4 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

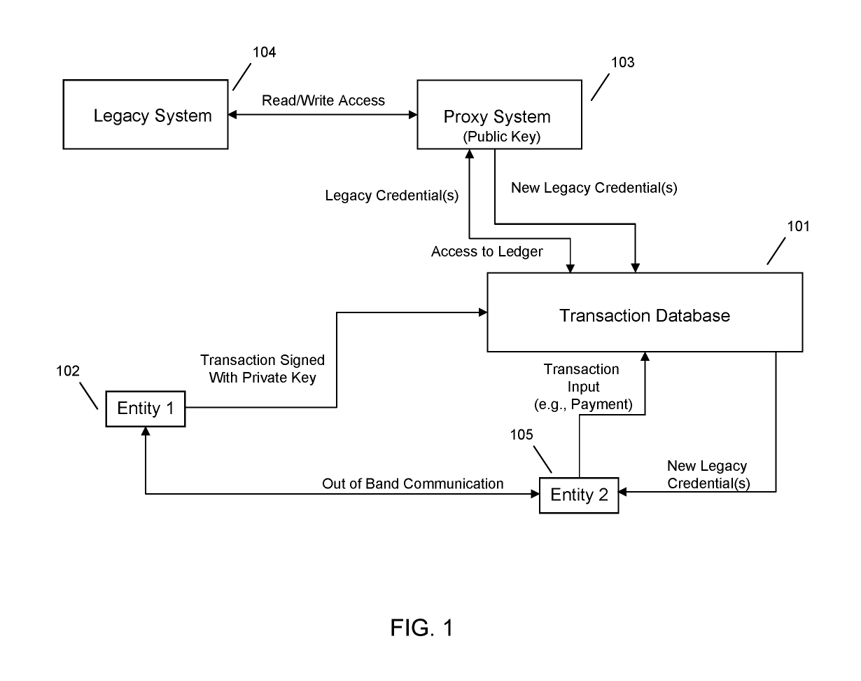

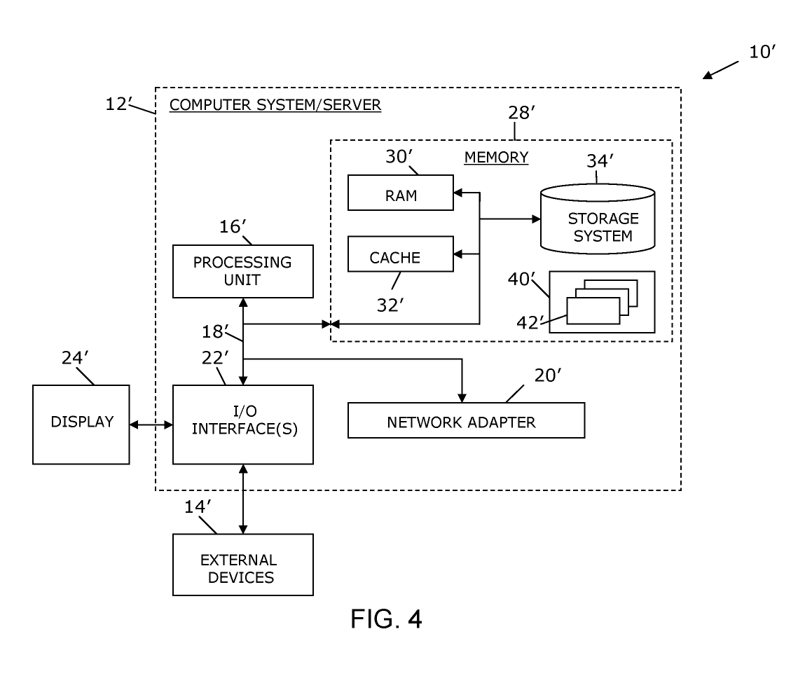

Specific reference will be made here below to FIGS. 1-4. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 4. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 4, whether on a server computer, a client computer, a node computer in a distributed network, or any combination thereof.

It is desirable to expand the use of time-sequenced immutable databases, for example ones that are constructed using block chain technology, beyond digital currency transactions and asset transfers that are conducted anonymously or pseudonymously. Further, it is desirable to permit interaction between legacy systems that operate using conventional credentials such as user name/password pairs, account numbers, etc., and a block chain database.

An embodiment thus links, via a proxy system (herein simply “proxy”), a legacy system (e.g., a credit card transaction processing system, a subscription-tracking database used by an asset redemption and fulfillment service, etc.) and an external database (e.g., an append-only publically verifiable block chain database conventionally used for anonymous or semi-anonymous crypto-currency transfers and smart contracts). In an embodiment, the proxy may be provided with read and write access to the legacy system (e.g., legacy database) in order to facilitate transactions, e.g., smart contract transactions using a block chain database.

Referring now to FIG. 1, a general system framework is illustrated for proxy mediated legacy transactions using a multi-tenant transaction database. An embodiment provides a method to bridge between processing on a public ledger such as provided by transaction database 101 between entities, e.g., Entity 1 (102 of FIG. 1) and Entity 2 (105 of FIG. 1), and processing using credential-based and/or proof-or-attestation-of-identity-required legacy services, such as provided by a legacy system 104. Such legacy systems may include, but are not limited to, credit, debit, or other payment processing systems, authorization-based form/contract-fill systems, digital content provider subscription systems, etc.

It is desirable that requirements for suitable demonstration of account access eligibility not be circumvented, i.e., it is advantageous that hidden or encrypted legacy credentials or identity proofs uploaded for inclusion on the public ledger of transaction database 101 be rendered unusable for transactions unintended by the legacy credential owners or credential issuers. This is true whether (a) such a legacy credential is uploaded for inclusion on the public ledger of the transaction database 101 by the legacy credential owner (e.g., entity 102 in the example of FIG. 1), or (b) such a legacy credential is uploaded for inclusion on the public ledger of the transaction database 101 by a proxy (e.g., 103 in the example of FIG. 1) for a legacy system (e.g., 104 in the example of FIG. 1) that uses the public ledger of the transaction database 101 to deliver an issued legacy credential to its intended owner or recipient.

In an example case, a legacy credential such as a user name/password pair for a legacy account (or sub-account, as further described herein) may be uploaded for inclusion on the public ledger of the transaction database 101 by the legacy credential owner, e.g., entity 102 of FIG. 1. A legacy credential owner may do so, for example, to include these data in a smart contract, e.g., with another entity such as entity 105 of FIG. 1. Since, in general, the public key corresponding to the private key used to sign a transaction on the public ledger of the transaction database 101 by the credential owner is not a priori known to be associated with the legacy credential owner by the legacy system 104, such signing does not prevent unauthorized access to or use of hidden or encrypted legacy credentials contained therein, unless measures are applied, as described further in connection with the various embodiments disclosed herein.

Conventionally, in certain legacy systems 104, attestations of identity may take the place of or supplement account credentials, or may be required in order to set or transmit credentials, e.g., legacy account credentials. Alternatively, such proof or attestation of identity may be required in order to activate received credentials that have been assigned to a particular individual or group. Proofs of identity may be static (such as a digital representation of a driver's license). Proofs of identity may be dynamic, such as a video clip of a person uttering a date-and-time or a challenge phrase (perhaps accompanied by a static proof of identity such as a driver's license).

When using a transaction database 101, such challenge phrases can appear in-the-clear on the transaction database 101. Credential-based payments may entail upload onto the transaction database 101 of encrypted static data (such as standard legacy data, e.g., card member data such as a credit card number, an expiration date, a card security code, a cardholder name, and a cardholder billing address). In an embodiment, security does not rely on a mandatory challenge-response mechanism since transaction database 101 transactions are typically not executed in real-time.

An embodiment securely initiates choice of a private—public key pair such that the private key can be expected to be used to sign subsequent transaction(s) from an entity involved in a valid transaction and the public key can be used to verify such signed transaction(s), i.e., so that even total compromise of the static credentials data does not enable an unauthorized individual or entity that lacks knowledge of the private key from successfully transacting. Digital signatures computed over transaction details are used, for example, in the Authorization Request Cryptogram (ARQC) in EMV specifications. EMV is a registered trademark of EMVCo, LLC in the United States and other countries.

In order to prevent misappropriation of a legacy credential uploaded to the transaction database 101, prior to (or during the process of) encryption of the legacy credential(s) (inclusive of but not limited to identity attestation(s), assertion(s), etc.), these legacy credentials are augmented or combined with a function of a public key corresponding to the private key used to digitally sign a transaction in the transaction database 101. For example, a smart contract signed by entity 102 for the benefit of entity 105 may contain a legacy credential of entity 102 included therewith, encrypted by a key that is available to proxy 103 via use of a private key of proxy 103 that corresponds to the public key of proxy 103 that is used by entity 102 during encryption processing of the augmented legacy credential.

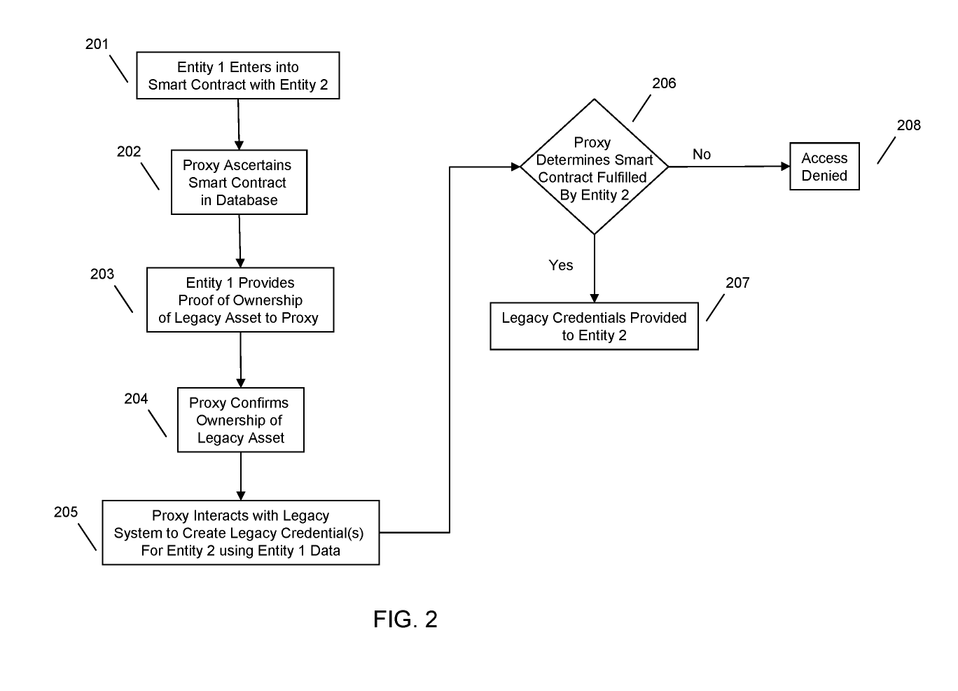

By way of specific example, if entity 102 wishes to sell part of a content subscription, e.g., access to a particular class or type of content, entity 102 may include an account number and password for accessing an account of entity 102 in legacy system 104. As further described in connection with FIG. 2, a proxy system 103 may act to verify entity 102's account credentials, i.e., by interacting with the legacy system, and thereafter set up a sub-account for entity 105 according to the terms of the smart contract. Thus, entity 105 may be granted new legacy credentials, e.g., legacy user name and password for a sub-account based on entity 102's legacy credentials.

Referring to FIG. 2 (and with continued reference to the system framework illustrated in FIG. 1), an example of proxy system mediated legacy transactions using multi-tenant transaction database is illustrated. In order to enter into a transaction in which legacy assets (e.g., account representing eligible access to resources (such as a subscription account), newly allocated sub-account, conventional payments such as credit card payments, etc.) are transferred or made available to another entity using the multi-tenant database, an embodiment provides a proxy system that interfaces with the multi-tenant database and the legacy system to facilitate compatibility there-between. A smart contract formed at 201 between Entity 1 (e.g., 102 of FIG. 1) and Entity 2 (e.g., 105 of FIG. 1), where Entity 1 wishes to grant Entity 2 partial or full use of Entity 1's account (that is enabled, e.g., via an account number/password pair for use of a digital content subscription) is used as a non-limiting example with continued reference to FIG. 1.

As illustrated in FIG. 2, the proxy may ascertain at 202 that within the multi-tenant database a smart contract exists. Entity 1 provides data within the smart contract establishing proof of ownership of a legacy credential, as illustrated at 203. In this example, the data for providing proof of ownership may be uploaded to the public ledger to establish that Entity 1 owns a particular legacy account, e.g., a digital content subscription owned by Entity 1 for use of the legacy system's digital content. The proxy confirms that Entity 1 in fact has access to the legacy asset at 204. This may be accomplished by means of the proxy accessing the legacy system, as illustrated in FIG. 1, e.g., by using the representation of the legacy account credential retrieved from the transaction database to confirm Entity 1's subscription data. An example of a representation of the legacy account credential (e.g., user name and password) is the combination or concatenation of user name, salt value, and hash (salt value ∥ password) where ∥ denotes concatenation and hash( ) is a one-way hash function.

The proxy may interact with the legacy system at 205 in order to facilitate distribution of the legacy asset according to the smart contract, as illustrated at 207. Of course, proxy may accomplish the processing referenced at 205, e.g., setting up a sub-account for Entity 2, retrieving or generating new legacy account credentials for Entity 2, etc., or simply signing to release previously created legacy credentials for Entity 2, prior to, during the process of, or after determining that the smart contract terms have been fulfilled at 206. In any case, the legacy credentials will not be released, e.g., transmitted, activated, etc., until the smart contract has been fulfilled, as determined at 206.

The proxy determines (or is apprised) that contractual terms are fulfilled at 205, e.g., as evidenced for example by data of the transaction database 101. If the smart contract is not completed, the proxy may deny access to the legacy asset, as illustrated at 208.

In order for the proxy to participate in issuing the legacy asset, here legacy credentials for Entity 2, the proxy acts to interface with the legacy system. By way of example, in the case of the smart contract between Entity 1 and Entity 2 of FIG. 1, proxy may interface with legacy system 104 of FIG. 1 to establish a sub-account within the legacy system 104 for the benefit of Entity 2, i.e., per the terms of the smart contract. Thus, if the terms of the smart contract are fulfilled, i.e., as typically determined by processing data in the multi-tenant database 101 of FIG. 1, the proxy may provide (directly or indirectly) the legacy credentials to Entity 2. As may be appreciated, the proxy may be granted read/write access to the legacy system's database or other assets in order to facilitate establishment of legacy credentials for Entity 2.

Although block chain systems may be equipped to address attempts at replay (or double spending), these conventional measures do not prevent misappropriation. Such misappropriation is prevented by an embodiment via use of the public key referenced in connection with the description of FIG. 1. This problem exists unless an effective countermeasure is incorporated, and such misappropriation could occur as follows.

By way of example, a digitally signed smart contract may include an invocation for an off-blockchain credit card payment, i.e., a legacy system is to be included in the processing of the smart contract. By way of specific example, Entity 2 (105 of FIG. 1) may need to pay Entity 1 (102 of FIG. 1) d dollars based on Entity 2's encrypted card member details included within the smart contract. This may be a term included in the smart contract, e.g., d dollars may be the payment for a new legacy credential issued to Entity 2. Problematic to conventional block chain transacting, another entity (Entity 3) may generate its own smart contract that incorporates Entity 2's encrypted card member details, so that Entity 2 unwittingly pays Entity 3 (or anyone else that Entity 3 chooses), rather than Entity 1, as originally intended. Such misappropriation may be performed preemptively, e.g., by a miner or mining pool on the block chain, or post-factum by any entity that sees the smart contract on the block chain. In such a case, there is presumed to be a party, such as one associated with Proxy System 103, that can decrypt at least those data of the smart contract that correspond to Entity 2's encrypted card member details, so as to recover Entity 2's card member details in order to request the payment to be handled using standard legacy credit card processing for completion of Entity 3's smart contract. Although this party can also generate a smart contract that exhibits a receipt once such a payment has been made, notification of misuse of Entity 2's card member details after Entity 2 obtains such receipt would have to go through standard (expensive, cumbersome) dispute resolution. Furthermore, the same type of attack could be mounted based on a reissued card, unless the problem is addressed intrinsically.

As described herein, in order to prevent such misappropriation, an embodiment, prior to (or during the process of) encryption of Entity 2's credential(s), augments or combines these with a function of the public key corresponding to the private key used to digitally sign the original smart contract, i.e., the smart contract between Entity 1 and Entity 2.

The function of the public key may be a one-way function. Augmenting or combining need not be separable or invertible in the absence of externally supplied input. For example, after decrypting, the verifier (e.g., proxy 103 of FIG. 1) can compute the function of the supplied or recovered or reconstructed public key, apply such functional value to a result of decryption, and verify whether the thus recovered credentials (or identity attestation(s), assertion(s), etc.) are legitimate. An exclusive-or operation is an example of a suitable augmenting or combining mechanism. Note that the public key used for signature verification may be sent explicitly, and thus supplied, with a signed transaction, or the public key used for signature verification may be recovered or reconstructed from the signed transaction and possibly additional provided bits.

In certain applications, an additional argument of encryption may be a function of a public key that is distinct from that corresponding to the private key used to sign the immediate transaction (e.g., smart contract), i.e., that is distinct from the public key that is used to verify the immediate transaction. This inclusion of an additional argument of encryption can be used to privately apprise the proxy (e.g., proxy 103 of FIG. 1) or other entity that performs decryption to expect the signature of a next or follow-on transaction (e.g., smart contract) to be verifiable using the public key that matches the function of a public key incorporated currently. The use of such a security measure implies that, subsequent to such apprising of the proxy, even stolen plaintext credentials (identity attestation(s), assertion(s), etc.) cannot be used for successful misappropriation unless the appropriate private key is also compromised. The procedure of incorporating as an argument of encryption, and thus privately conveying, a function of a public key to be used for verification of a next or follow-on transaction can be iterated to maintain un-linkability of transactions. During such iteration, a function of the public key that is used to verify the immediate transaction may or may not be included as an argument of encryption or as combined with the credential(s) prior to (or during the process of) encryption. The proxy 103 can track the function of a public key that was last supplied with that same set of credentials. If privacy or un-linkability is not a concern, then the public key used to verify can be considered a constant relative to the particular set of credentials (identity attestation(s), assertion(s), etc.) without the need to add a function of a public key as an additional argument of encryption. That is, a primary combining mechanism suffices where privacy is not a primary concern.

In certain applications, an additional argument of encryption may be a function of identity of an entity, e.g., Entity 2 in the example of paying d dollars to obtain legacy credentials, to which the newly issued legacy credentials have been assigned (for example, credential(s) for a sub-account allowing access to a particular content type in a content subscription). In such case, use of these newly issued legacy credentials may have to be accompanied by an acceptable proof or attestation of identity, e.g., by the receiving entity (here, Entity 2). In certain applications, legacy credentials may be obtained without payment, but may require an acceptable proof or attestation of identity as a condition of successfully using such credentials. In certain applications, an additional argument of encryption may be a function of identification of a group. In such case, use of newly issued legacy credentials may have to be accompanied by an acceptable proof or attestation of membership in the group. Proofs or attestations of identity or group membership may or may not have to be repeated with subsequent uses of credentials following the first use of credentials.

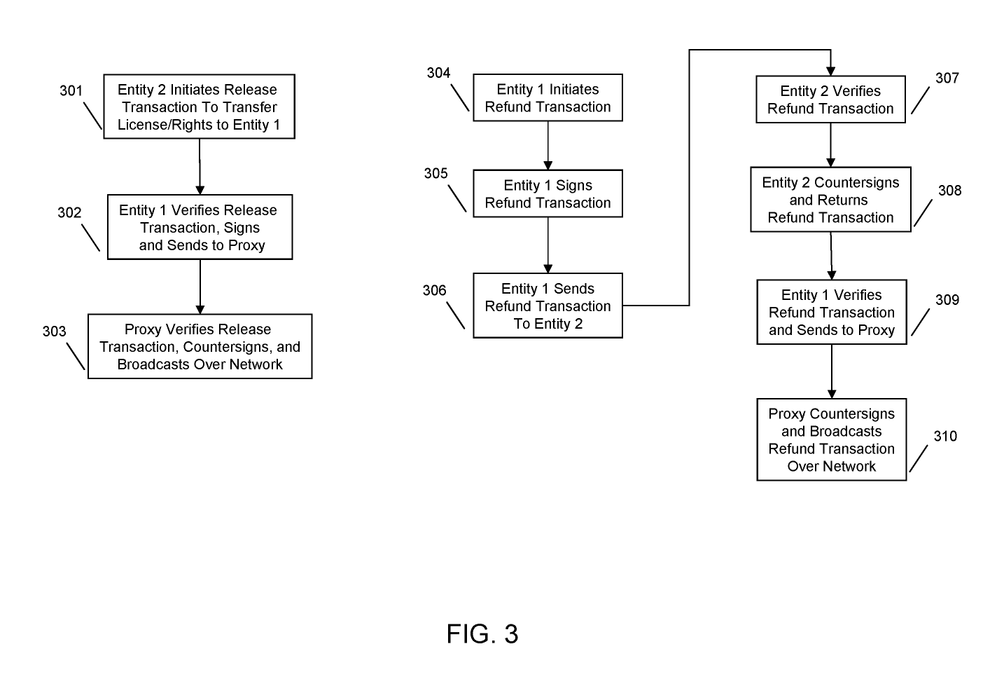

FIG. 3 provides a non-limiting example of such a proxy mediated smart contract between two entities. As illustrated, at 301 Entity 2 initiates a release transaction to where Entity 1 agrees to transfer x coins to Entity 2 in exchange for subscription credentials, representing, e.g. (sub-license) content rights, provided to Entity 1 by the service provider (SP) proxy upon request by Entity 2. Note that this is opposite of the flow of the legacy credentials outlined in FIG. 1. The x coins may be transferred initially to a multi-signature address comprised of Entity 1's block chain address, Entity 2's block chain address, and a service provider (SP) proxy's block chain address. The transaction may stipulate that all three signatures are required to spend the x coins.

Entity 2 initiates the transaction releasing x coins from the multi-signature address to a single block chain address for which Entity 2 has access to the corresponding private key. This transaction includes script Script_Entity2:

Generated Elliptic Curve Diffie-Hellman (ECDH) ephemeral public key;
EncryptK (Entity 2's SP account number and Entity 2's SP password, combined with Entity 2's block chain address); and (sub-license) content rights, where EncryptK( ) denotes encryption using key K.

The combination may be some form of exclusive-or operation, for example, where such operation is invertible since Entity 2's block chain address is derivable from Entity 2's signature verification public key that is part of or that can be reconstructed from the transaction signed by Entity 2. K is derivable by Entity 2 (Entity 2's device) using the generated ECDH ephemeral private key and the proxy (SP) Proxy's ECDH public key (available, for example, from the SP website). K will be re-derivable by the proxy using the proxy ECDH private key and Entity 2's generated ECDH ephemeral public key included within Script_Entity 2.

Entity 2 signs the release transaction and sends the release transaction to Entity 1. Entity 1 verifies the release transaction and adds script Script_Entity1 if verification passes (and sub-license in the release transaction is as expected by Entity 1), as illustrated at 302. Script_Entity1 may be represented as: Entity 1's ECDH public key (where the corresponding private key must be available to Entity 1 (Entity 1's device) to later retrieve Entity 1's SP credentials, e.g., comprised of Entity 1's account number and password).

Entity 1 signs the (resultant) release transaction at 302, and sends the release transaction to the proxy. The proxy verifies the release transaction and adds a script (Script_Proxy) if the verification passes and the sub-license included in the release transaction is consistent with the current rights status of Entity 2's license within the legacy database (e.g., service provider's database), as illustrated at 303. Script_Proxy may be comprised of a generated ECDH ephemeral public key and EncryptK′(Entity 1's new legacy account number and Entity 1's new (e.g., initial, default) password). K′ is derivable by the proxy using the generated ECDH ephemeral private key and Entity 1's ECDH public key included within Script_Entity 1. K′ will be re-derivable by Entity 1 using Entity 1's ECDH private key and the proxy's ECDH ephemeral public key included within Script_Proxy. EncryptK′( ) denotes encryption using key K′.

The proxy countersigns the release transaction and broadcasts the release transaction over block chain network, as illustrated at 303. The legacy system database (e.g., service provider database) is also modified to reflect the post-contract rights status of Entity 2's license and adds Entity 1's new account registration (e.g., including the new account number and password) and license. As described herein, the proxy may process the updates to the legacy system database.

Prior to agreeing to transfer funds to Entity 2, e.g., to sign the release transaction at 302, Entity 1 may initiate a refund transaction, illustrated in FIG. 3 at 304. For example, the refund transaction may stipulate that if the x coins are not spent after 30 days, the x coins revert back to Entity 1's block chain address. Entity 1 signs the refund transaction at 305 and sends the refund transaction to Entity 2 at 306. Entity 2 verifies the refund transaction at 307, countersigns, and returns the refund transaction to Entity 1 at 308. The timing of these steps may be changed. For example, Entity 2 may send the signed refund transaction at the time Entity 2 sends Entity 1 a transaction releasing x coins from the multi-signature address to Entity 2, i.e., as illustrated at step 301.

Entity 1 verifies the refund transaction and sends the refund transaction to proxy for countersignature at 309. Proxy countersigns and broadcasts the refund transaction over the block chain network at 310. Again, Entity 1 does not process the release transaction at 302 unless satisfactorily receiving Entity 2's countersignature on this refund transaction, as illustrated at 308.

As an alternative to managing the 30-day aspect of the example refund transaction via block chain logic, proxy's external policy may be to sign either the refund transaction or the release transaction.

Once Entity 1 has the signed refund transaction from Entity 2, the smart contract may be added to the block chain, e.g., transactional database 101 of FIG. 1. Thus, the proxy (e.g., Proxy 103 of FIG. 1) may interact with the legacy system (e.g., system 104 of FIG. 1) in order to fulfill the terms of the smart contract, e.g., create new legacy credentials for Entity 1. Likewise, as has been described herein, the proxy may interface with other legacy systems, e.g., credit card transaction processing systems (if Entity 1 in the example of FIG. 3 had agreed to pay by credit card), in order to facilitate completion of the smart contract.

Thus, the proxy system described herein acts to verify the identities of the transacting entities, facilitate confirmation of completed smart contract terms, including the ability to interface with legacy systems to process off block chain transactions, and to facilitate security by accessing encrypted data included in the block chain by the transacting entities.

As shown in FIG. 4, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for proxy system mediated legacy transactions using multi-tenant transaction database, comprising:
utilizing at least one processor to execute computer code that performs the steps of:
ascertaining, using a processor associated with a proxy system, that a first transacting entity and a second transacting entity have placed a transaction on a multi-tenant transaction database, the transaction including transfer of a legacy asset;
decrypting, using a processor associated with the proxy system, a legacy system account access credential of the second transacting entity included in the transaction, the decrypting comprising recovery of a function of a public key corresponding to a private key associated with the second transacting entity;
confirming, using a processor associated with the proxy system, that the legacy system account credential authorizes the second transacting entity to transfer the legacy asset; and
transferring, using a processor associated with the proxy system, the legacy asset from the second transacting entity to the first transacting entity.

2. The method of claim 1, wherein the confirming includes communicating with the legacy system.

3. The method of claim 1, wherein the transferring comprises communicating with the legacy system.

4. The method of claim 3, wherein the communicating comprises obtaining a new legacy system account access credential for the first transacting entity.

5. The method of claim 4, wherein the legacy asset is transferred by releasing the new legacy system account access credential to the first transacting entity.

6. The method of claim 1, further comprising confirming, using a processor associated with the proxy system, that the first transacting entity and the second transacting entity have agreed upon an amount in exchange for the transfer of the legacy asset.

7. The method of claim 6, wherein the confirming comprises determining digital data required by a smart contract exists within the multi-tenant transactional database.

8. The method of claim 7, wherein the determining comprises verifying one or more digital signatures.

9. The method of claim 1, wherein the proxy system and the legacy system have established a trusted relationship.

10. The method of claim 1, wherein the legacy asset comprises conventional currency, banking account balance(s) and/or debit/credit card account(s).

11. An apparatus for proxy system mediated legacy transactions using multi-tenant transaction database, the apparatus comprising:
at least one processor; and
a computer readable storage medium having computer readable program code embodied therewith and executable by the at least one processor, the computer readable program code comprising:
computer readable program code that ascertains, using a processor associated with a proxy system, that a first transacting entity and a second transacting entity have placed a transaction on a multi-tenant transaction database, the transaction including transfer of a legacy asset;
computer readable program code that decrypts, using a processor associated with the proxy system, a legacy system account access credential of the second transacting entity included in the transaction, wherein the computer readable program that decrypts recovers a function of a public key corresponding to a private key associated with the second transacting entity;
computer readable program code that confirms, using a processor associated with the proxy system, that the legacy system account credential authorizes the second transacting entity to transfer the legacy asset; and
computer readable program code that transfers, using a processor associated with the proxy system, the legacy asset from the second transacting entity to the first transacting entity.

12. A computer program product for proxy system mediated legacy transactions using multi-tenant transaction database, the computer program product comprising:
a computer readable storage medium having computer readable program code embodied therewith that is executable by at least one processor, the computer readable program code comprising:
computer readable program code that ascertains, using a processor associated with a proxy system, that a first transacting entity and a second transacting entity have placed a transaction on a multi-tenant transaction database, the transaction including transfer of a legacy asset;
computer readable program code that decrypts, using a processor associated with the proxy system, a legacy system account access credential of the second transacting entity included in the transaction, wherein the computer readable program that decrypts recovers a function of a public key corresponding to a private key associated with the second transacting entity;
computer readable program code that confirms, using a processor associated with the proxy system, that the legacy system account credential authorizes the second transacting entity to transfer the legacy asset; and
computer readable program code that transfers, using a processor associated with the proxy system, the legacy asset from the second transacting entity to the first transacting entity.

13. The computer program product of claim 12, wherein the computer readable program code that confirms comprises computer readable program code that communicates with the legacy system.

14. The computer program product of claim 12, wherein the computer readable program code that transfers comprises computer readable program code that communicates with the legacy system.

15. The computer program product of claim 14, wherein the computer readable program code that communicates comprises computer readable program code that obtains a new legacy system account access credential for the first transacting entity.

16. The computer program product of claim 15, wherein the computer readable program code that transfers comprises computer readable program code that releases the new legacy system account access credential to the first transacting entity.

17. The computer program product of claim 12, further comprising computer readable program code that confirms, using a processor associated with the proxy system, that the first transacting entity and the second transacting entity have agreed upon an amount in exchange for the transfer of the legacy asset.

18. The computer program product of claim 17, wherein the computer readable program code that confirms that the first transacting entity and the second transacting entity have agreed upon an amount in exchange for the transfer of the legacy asset comprises computer readable program code that determines digital data required by a smart contract exists within the multi-tenant transactional database.

19. The computer program product of claim 18, wherein the computer readable program code that the digital data required by a smart contract exist within the multi-tenant transactional database comprises computer readable program code that verifies one or more digital signatures.

20. The computer program product of claim 12, wherein the proxy system and the legacy system have established a trusted relationship.

21. The computer program product of claim 12, wherein the legacy asset comprises conventional currency, banking account balance(s) and/or debit/credit card account(s).

22. A method for proxy system mediated legacy transactions that are executed externally to a multi-tenant transaction database, comprising:
utilizing at least one processor to execute computer code that performs the steps of:
ascertaining, using a processor associated with a proxy system, that a first transacting entity and a second transacting entity each contributed towards submitting a transaction for placement on the multi-tenant transaction database, the transaction including a representation of transfer of a legacy asset; and
decrypting, using a processor associated with the proxy system, an encrypted, augmented legacy system account access credential of the second transacting entity included in the transaction, the decrypting resulting in recovery of a function of a public key corresponding to a private key associated with the second transacting entity, wherein said private key is associated with the second transacting entity by the second transacting entity using the private key to contribute towards submitting the transaction for placement on the multi-tenant database;
confirming, using a processor associated with the proxy system, that the legacy system account credential authorizes the second transacting entity to transfer the legacy asset; and
transferring, using a processor associated with the proxy system, the legacy asset from the second transacting entity to the first transacting entity.

23. The method of claim 22, wherein said decrypting results in recovery of a function of a first public key corresponding to a private key associated with the second transacting entity and recovery of a function of a second public key corresponding to a private key associated with the second transacting entity.

24. The method of claim 23, wherein said first private key is associated with the second transacting entity by the second transacting entity using the first private key to contribute towards submitting the transaction for placement on the multi-tenant database, and wherein said second private key is associated with the second transacting entity by the second transacting entity using the second private key to contribute towards submitting a future transaction for placement on the multi-tenant database.

25. A method for proxy system mediated legacy transactions that are executed externally to a multi-tenant transaction database, comprising:
utilizing at least one processor to execute computer code that performs the steps of:
ascertaining, using a processor associated with a proxy system, that a first transacting entity and a second transacting entity each contributed towards submitting a transaction for placement on the multi-tenant transaction database, the transaction including a representation of transfer of a legacy asset; and
verifying, using a processor associated with the proxy system, a signature that is generated by the second transacting entity as part of contributing towards submitting the transaction for placement on the multi-tenant database, wherein said verifying comprises using a public key, wherein a function of the public key is recovered by a processor associated with the proxy system via decryption of a previous transaction submitted by the same entity for placement on the multi-tenant database.

26. The method of claim 25, wherein determination that an entity is the same entity comprises recovering via decryption, using a processor associated with the proxy system, the same legacy system account access credential from the transaction as from a previous transaction.
